(19) United States
(12) Patent Application Publication
(10) Pub. No.: US 2025/0303642 A1
(43) Pub. Date: Oct. 2, 2025

(54) ADDITIVELY MANUFACTURED MICROSUPPORT ARRAYS AND METHODS OF USING THE SAME

(71) Applicant: Carbon, Inc., Redwood City, CA (US)

(72) Inventors: Justin Kirschbrown, San Mateo, CA (US); Elliott Steele Baker, San Mateo, CA (US)

(21) Appl. No.: 19/089,125

(22) Filed: Mar. 25, 2025

Related U.S. Application Data
(60) Provisional application No. 63/569,921, filed on Mar. 26, 2024.

(51) Int. Cl. B29C 64/40; B33Y 10/00; B33Y 80/00

(52) U.S. Cl. CPC B29C 64/40; B33Y 10/00; B33Y 80/00

(57) ABSTRACT

A microsupport array for additive manufacturing includes a plurality of microsupports on a build platform. Each microsupport includes a base portion on the build platform, a rail portion configured to attach to an additively manufactured object, and a body portion connecting the base portion and the rail portion, optionally wherein the body portion comprises a deflection point. A part of the body portion is configured to break upon removal of the additively manufactured object from the build platform at the deflection point, when present.

### CROSS-REFERENCE TO RELATED APPLICATION

This application claims priority to U.S. Provisional Application No. 63/569,921, filed on Mar. 26, 2024, the disclosure of which is incorporated herein by reference in its entirety.

### FIELD

The present invention relates to articles and methods for making three-dimensional objects by an additive manufacturing process.

### BACKGROUND

The production of three-dimensional objects from polymerizable resins by stereolithography has been known for some time (see, e.g., U.S. Pat. No. 5,236,637 to Hull). Originally, such techniques were considered slow and typically limited to resins that produced brittle or fragile objects suitable only as prototypes. A more recent technique known as continuous liquid interface production (CLIP) allows both more rapid production of objects by stereolithography (see, e.g., U.S. Pat. No. 9,205,601 to DeSimone et al.) and the production of parts with isotropic mechanical properties (see R. Janusziewicz et al., Layerless fabrication with continuous liquid interface production, Proc. Natl. Acad. Sci. USA 113, 11703-11708, Oct. 18, 2016). Along with the introduction of a variety of different dual cure resins for stereolithography (see, e.g., U.S. Pat. No. 9,453,142 to Rolland et al.), these developments make possible the production of a much greater variety of functional, useful, objects suitable for real world use.

Nevertheless, there remains a need for improved apparatus and processes that increase manufacturing quality and efficiency.

### SUMMARY

Provided according to embodiments of the invention are microsupport arrays for additive manufacturing that include a plurality of microsupports on a build platform. In some embodiments, each microsupport comprises:
(i) a base portion on the build platform,
(ii) a rail portion configured to attach to an additively manufactured object, and
(iii) a body portion connecting the base portion and the rail portion, optionally wherein the body portion comprises a deflection point, wherein a part of the body portion (e.g., at the deflection point) is configured to break upon removal of the additively manufactured object from the build platform.

Also provided according to some embodiments of the invention are additively manufactured combinations that include a microsupport array of the invention; and an additively manufactured object (e.g., a polymeric object) attached to the microsupport array.

Further provided according to some embodiments of the invention are methods of additively manufacturing an object that include:
(a) additively manufacturing a microsupport array directly or indirectly on a build platform;
(b) additively manufacturing the object on the microsupport array; and
(c) removing the object from the microsupport array, wherein the microsupport array comprises a plurality of microsupports and each microsupport includes:
   (i) a base portion directly or indirectly on the build platform,
   (ii) a rail portion that attaches to the object, and
   (iii) a body portion connecting the base portion and the rail portion,
wherein a portion of the microsupport is configured to break upon removal of the object from the microsupport array such that at least part of the rail portion remains in the object after removal step (c). Also provided are additively manufactured objects fabricated by a method of the invention.

### BRIEF DESCRIPTION OF THE DRAWINGS

FIGS. 1A-1D illustrate cross sections of microsupports according to embodiments of the invention.

FIGS. 2A-2C illustrate cross sections of microsupports according to embodiments of the invention.

FIGS. 3A-3B illustrate microsupport arrays according to embodiments of the invention.

FIGS. 4A-4B illustrate an example of perforations that may be present in microsupports according to embodiments of the invention.

FIG. 5 is digital model of an additively manufactured object on a microsupport array according to an embodiment of the invention.

FIGS. 6-7 are photographs of additively manufactured objects on microsupport arrays according to embodiments of the invention.

FIGS. 8A-8B are digital models of microsupport arrays and microsupport array bases according to embodiments of the invention.

FIGS. 9A-9B are digital models of microsupport arrays in multi-tiered structures according to embodiments of the present invention.

FIGS. 10A-10B are digital models of support pillars and support beams that may be present in multi-tiered structures according to embodiments of the invention.

FIG. 11 is a photograph of additively manufactured objects formed according to embodiments of the invention.

FIG. 12 is a diagram of an additive manufacturing system that may be used in embodiments of the present invention.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

As used herein, a “plurality” of any element refers to two or more (e.g., 2, 3, 4, 5, 10, 15, 20, 30, 40, 50, 100, 200 or a range defined between any two of the foregoing values) of such elements and may include 10%, 20%, 30%, 40%, 50%, 60%, 70%, 80%, 90%, 95%, 99% or 100%, or any range defined therein, of the total number of elements.

All patents or published patent applications referenced are herein incorporated by reference in their entirety. In the case of conflicting terminology, the present application controls.

### Microsupport Arrays

Provided according to embodiments of the invention are microsupport arrays that may be useful for additively manufacturing objects. Additively manufactured articles are fabricated on the microsupport arrays, which may provide several benefits in printing and/or post-processing. For example, additively manufacturing objects on the microsupport arrays may allow access to the underside of the formed objects, enabling easier cleaning and/or draining of hollow spaces in the object; may provide an aesthetic texture to the formed objects; may facilitate removal of objects from platform; and/or may increase print accuracy. The microsupport arrays may be additively fabricated directly on a build platform of an additive manufacturing apparatus, or such arrays may be indirectly fabricated on the build platform by being fabricated on one or more intermediate layers, including intermediate additively manufactured layer(s) or other multi-tiered structures.

Microsupports of the invention are small structures that are positioned in an array directly or indirectly on the build platform to act as an elevated substrate on which one or more three-dimensional object(s) may be fabricated. The microsupports have a base width in a range of 0.025 mm to 30 mm (e.g., 0.5 mm to 2 mm, including 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, and any range defined between any two of the foregoing values); a height in a range of 0.025 mm to 30 mm (e.g., 0.5 mm to 4 mm, including 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.2 mm, 2.4 mm, 2.6 mm, 2.8 mm, 3.0 mm, 3.2 mm, 3.4 mm, 3.6 mm, 3.8 mm, 4.0 mm, and any range defined between any two of the foregoing values) and any length, but generally no longer than the longest width of the build platform, including corner to corner hypotenuse widths (e.g., in a range of 0.5 mm to 1000 mm). In some embodiments, the microsupports are elongate structures such that the length of the microsupport 100 is at least 5, 10, 20, 30, 40, 50, 60, 70, 80, 90, or 100 times greater than the height and/or width of the microsupport.

A microsupport array of the invention includes a plurality of microsupports on (which includes directly on and indirectly on) a build platform. A microsupport of the invention includes (i) a base portion on (directly or indirectly) the build platform, (ii) a rail portion configured to attach or attached to an additively manufactured object thereon, and (iii) a body portion connecting the base portion and the rail portion, wherein the body portion optionally includes one or more deflection point(s), and wherein a portion of the microsupport (e.g., a deflection point) is configured to break upon removal of the additively manufactured object from the microsupport array.

A deflection point is an area at an angular intersection or vertex where at least two surfaces that extend in different directions meet or intersect. The deflection point may be at an intersection that forms an acute or an obtuse angle and includes curved or irregular intersections. The surfaces may be curved, planar or irregularly shaped. The deflection point may be at position on the microsupport that is a regional minimum cross sectional area (such as when the deflection point is at an intersection that forms an acute angle between two surfaces) or at a regional maximum cross sectional area (such as when the deflection point is at an intersection that forms an obtuse angle between two surfaces).

In some embodiments, a portion of the microsupport is configured to break, such as upon removal of the additively manufactured object from the microsupport array. For example, a frangible section that is structurally prone to breakage may be provided in the microsupport. The portion of the microsupport that is above a frangible section is configured to break upon removal of the additively manufactured object from the microsupport array. For example, the diameter of the microsupport may be smaller at a frangible section than in other sections. In some embodiments, the frangible section, which has a greater tendency to break than surrounding areas of the microsupport, may be additively manufactured using additive manufacturing parameters to increase the tendency of the microsupport to break in the frangible section. For example, the print speed may be increased and/or the density of the polymerized resin may be reduced to provide a frangible section.

The microsupport array may be fabricated by an additive manufacturing process or other suitable manufacturing process and positioned on a build platform. In some embodiments, the microsupport array may be additively manufactured on the build platform and then subsequently used to support an additively manufactured object that is additively manufactured on the same build platform used to additively manufacture the microsupport array. The polymerizable liquid used to form the microsupport array may be the same as that used to form the additively manufactured object, or a different polymerizable liquid may be used for the microsupport array and the additively manufactured object on the microsupport array. In particular embodiments described in more detail herein, a plurality of microsupport arrays may be additively manufactured on the same build platform and separated by support pillars or other structures so that additional additively manufactured objects may be formed successively in a single three dimensional printing step without removing the first microsupport array from the build platform.

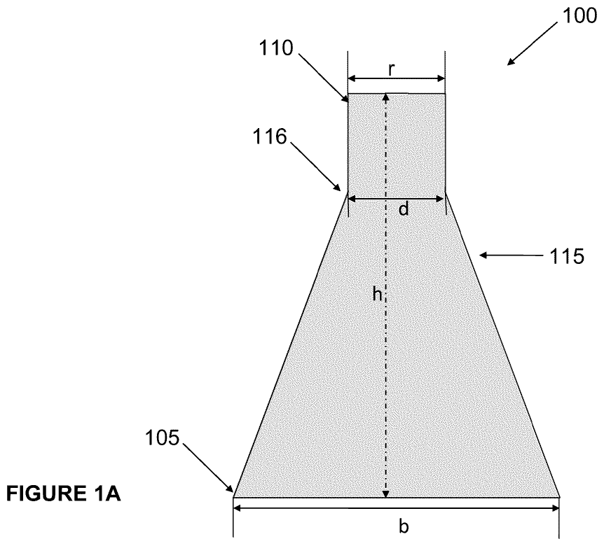

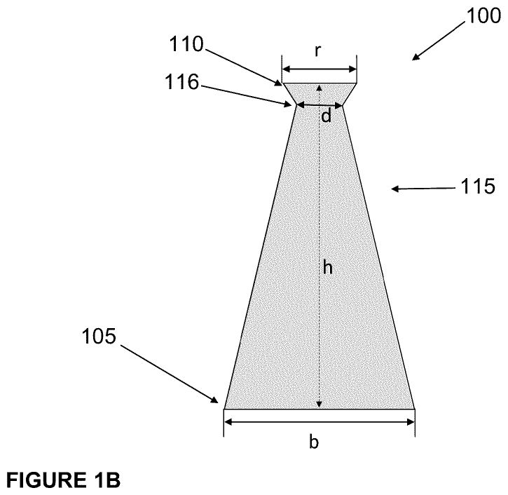

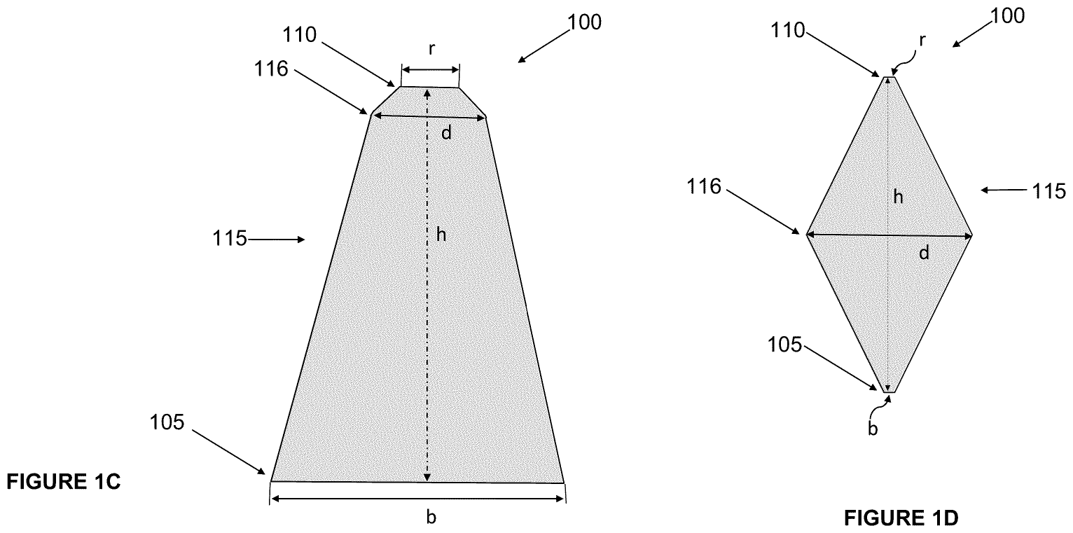

The structure and configuration of the microsupports of the invention may vary. Examples of cross sections of microsupports are shown in FIGS. 1A-1D. Microsupport 100 having a height h includes base portion 105 (having a width b) on the build platform (not shown); rail portion 110 (having a width r) that is configured to attach or is attached to an additively manufactured object (not shown) built thereon; and body portion 115 connecting rail portion 110 and base portion 105.

In the microsupports shown in FIGS. 1A-1D, a concave deflection point 116 having width d is present in body portion 115. In FIG. 1A, the width d at concave deflection point 116 is approximately equal to the width r of rail portion 110 and less (e.g., less than half) of the width b of the base portion 105. However, in some embodiments, as shown in FIG. 1B, the width r of rail portion 110 is greater than the width d at concave deflection point 116. The deflection point 116 may also be convex. For example, as shown in FIG. 1C, the width r of rail portion 110 is less than the width d at convex deflection point 116. In some embodiments, as shown in FIG. 1D, the width r of rail portion 110 and the width b of base portion 105 are both less than the width d at convex deflection point 116. In some embodiments, a ratio of width r of the rail portion 110 to the width d of deflection point 116 is in a range of 300:1 to 1:300 (e.g., in a range of 10:1 to 1:10, or 1:7 to 7:1). In some embodiments, a ratio of the width r of rail portion 110 to the width b of base portion 105 is in a range of 300:1 to 1:300 (e.g., in a range of 10:1 to 1:10 or 1:7 to 7:1). In some embodiments, a ratio of the width b of base portion 105 to the width d of deflection point 116 is in a range of 300:1 to 1:300 (e.g., in a range of 10:1 to 1:10 or 1:7 to 7:1).

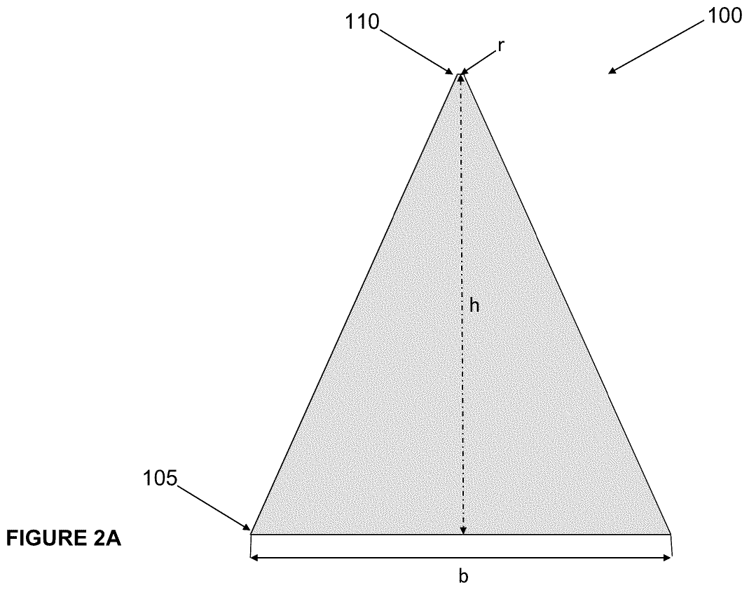

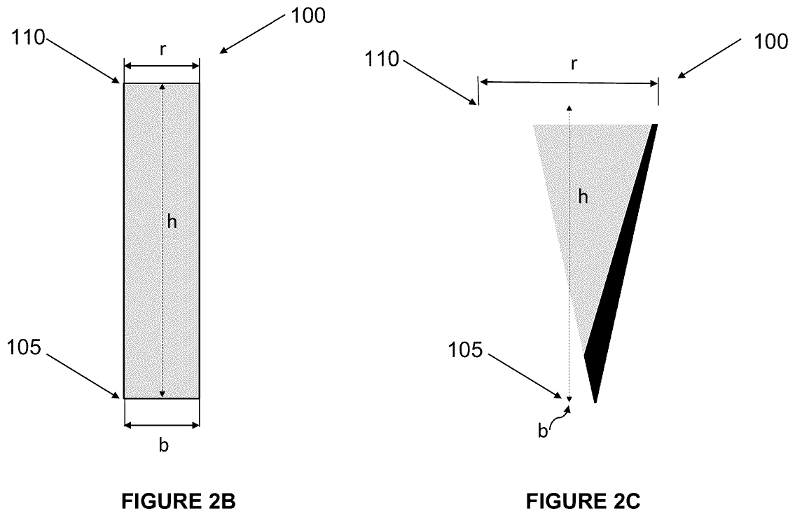

In some embodiments of the invention, body portion 115 does not include deflection point 116. In FIG. 2A, the width b of base portion 105 is substantially greater than the width r of the rail portion 110. However, as shown in FIG. 2B, the width b of base portion 105 may be substantially the same as the width r of the rail portion 110. Additionally, as shown in FIG. 2C, in some embodiments, the width b of base portion 105 is substantially smaller than the width r of rail portion 110. The ratio of the widths of the rail portion 110 and base portion 105 may be varied as described above, but in some embodiments, a ratio of the width r of the rail portion 110 to the width b of the base portion 105 is in a range of 10:1 to 1:10 (e.g., 7:1 to 1:7).

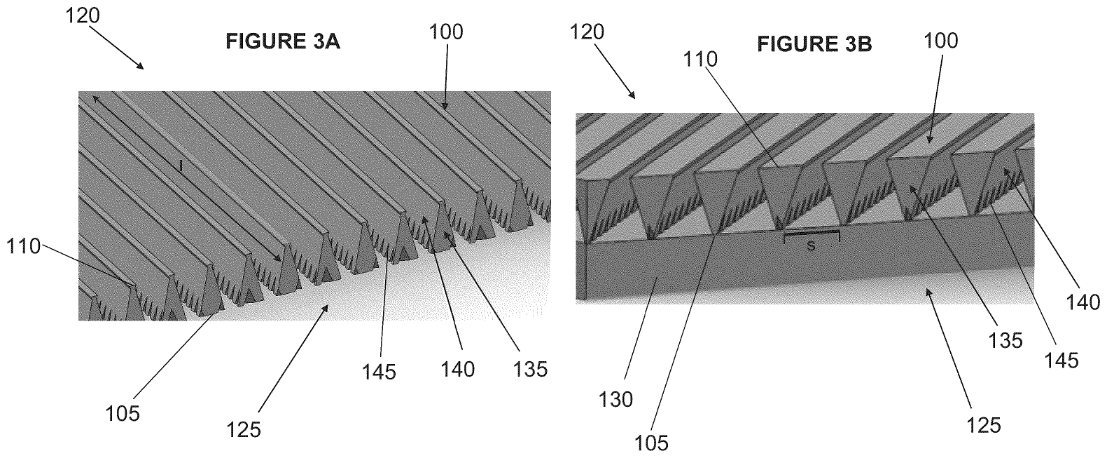

FIGS. 3A and 3B illustrate microsupport arrays 120 according to some embodiments of the invention, although the microsupport arrays 120 may take many different configurations, as discussed below. These microsupport arrays 120 include substantially parallel elongate microsupports 100. Each of the microsupports 100 in the microsupport array 120 includes at least one end face 135 and at least two side walls 140 connecting base portion 105 to rail portion 110. In FIG. 3A, the microsupport array 120 is directly on build platform 125. In FIG. 3B, the microsupport array 120 is on an intermediate build surface 130 that is directly on (but may also be indirectly on) build platform 125. The distance between adjacent microsupports 100 may vary. However, in some embodiments, the distance s (see FIG. 3B) between adjacent microsupports 100 is in a range of 0.025 mm to 10 mm (e.g., 0.5 mm to 3 mm or 1 mm to 2 mm). In some cases, the length l of the elongate microsupports is at least 5, 10, 20, 30, 40, 50, 60, 70, 80, 90, or 100 times greater than the height and/or width of the microsupport.

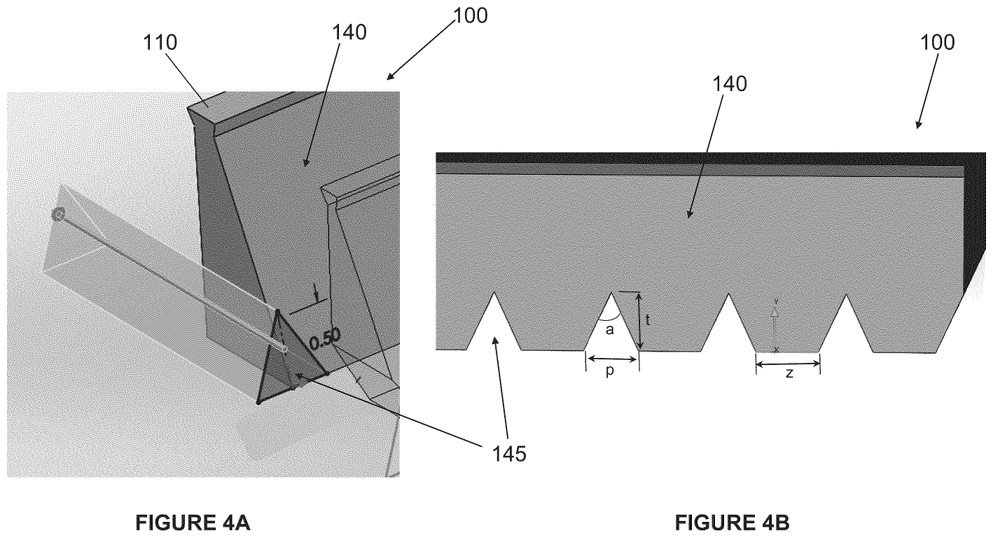

The end face 135 and side walls 140 of microsupports 100 may be solid and continuous or, as shown in FIGS. 3A and 3B, there may be perforations 145 therein. Perforations 145 may allow increased oxygen concentration in the resin by decreasing print forces by decreasing resin stagnation and increasing resin flow during printing. The perforations may also facilitate cleaning with a solvent during post-processing. Perforations 145 may be of any shape, including circular, ovate, polygonal (e.g., triangular, rectangular, etc.) and any suitable size. In some embodiments, the perforations 145 have a height such that the ratio of microsupport height to perforation height is in a range of 1:1 to 100:1 (e.g., 2:1 to 5:1 or 3:1 to 4:1). In some embodiments, at least 5%, 10%, 20%, 30%, 40% or more of the microsupport 100 is absent due to perforations 145 therein. In some embodiments, the distance between adjacent perforations 145 in the microsupport 100 is in a range of 0.025 mm to 30 mm (e.g., 0.1 mm to 5 mm or 0.3 mm to 1 mm). The distance between perforations 145 may be regular or irregular. FIGS. 4A and 4B provide a magnified view of certain triangular perforations 145 in microsupports 100. Such triangular perforations 145 optionally have a width p in a range of 0.3 mm to 0.8 mm, an internal angle a in a range of 40 to 60, and/or a height t in a range of 0.3 mm to 0.8 mm, with a distance z between adjacent perforations 145 in the microsupport 100.

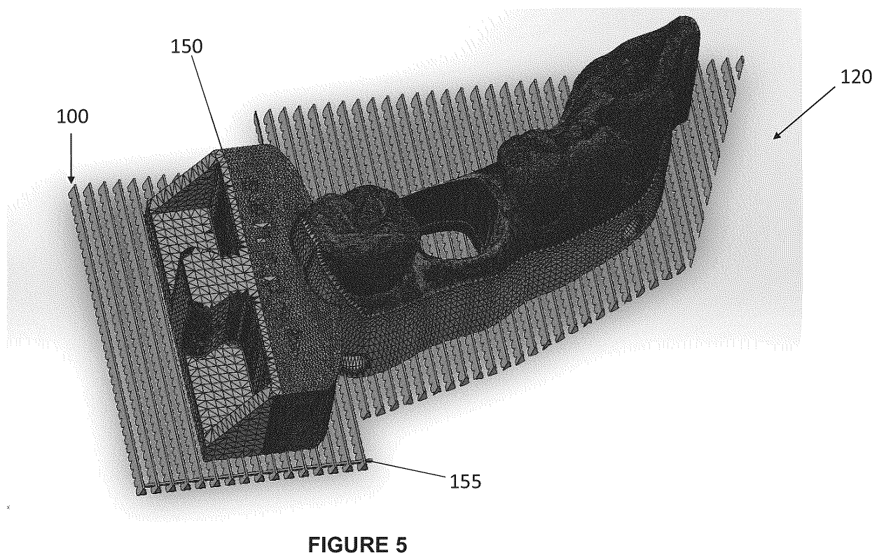

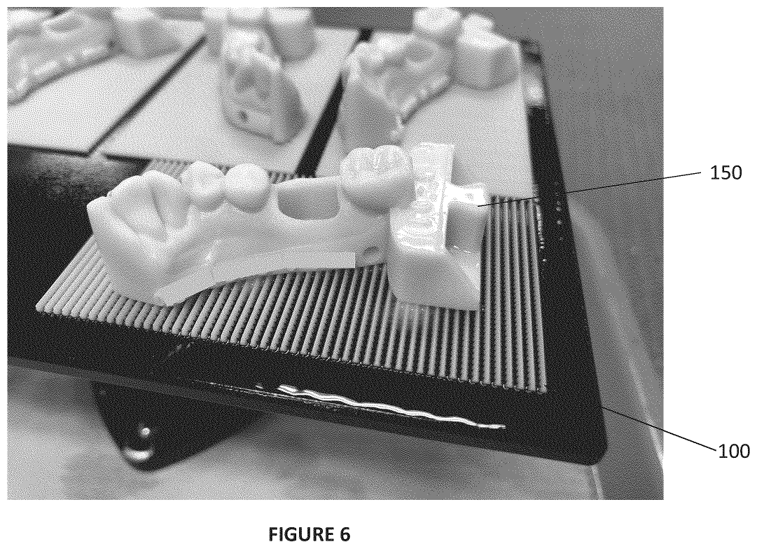

The microsupport array 120 comprises a plurality of microsupports 100, which includes 2 or more microsupports 100, including 2 to 10, 20, 30, 40, 50, 100, 200, 500 or more microsupports 100. In some embodiments, the microsupports 100 are on at least 20%, 30%, or 40% (e.g., at least 50%, 60%, or more) of the surface area of the build platform 125 (whether the microsupports 100 are directly or indirectly on the build platform). In some embodiments, at least 10%, 20%, 30%, 40% or more of the surface area of a face or side of an object (e.g., the face or side facing the build platform) on the microsupport array 120 contacts with the microsupport array 120. As shown in FIG. 5, in some embodiments, the microsupports 100 may be elongate, and the microsupport array 120 comprises a plurality of elongate microsupports 100 (e.g., parallel or substantially parallel elongate microsupports), which may also be referred to as a linear microsupport array 120. In other embodiments, the microsupports 100 may be curved. Further, in some embodiments, the plurality of microsupports 100 is arranged in a pattern such as, for example, circle, triangle, diamond, polygon (e.g., hexagon), and a combination of any of the foregoing. In some embodiments, a configuration of the plurality of microsupports 100 is irregular and/or non-uniform.

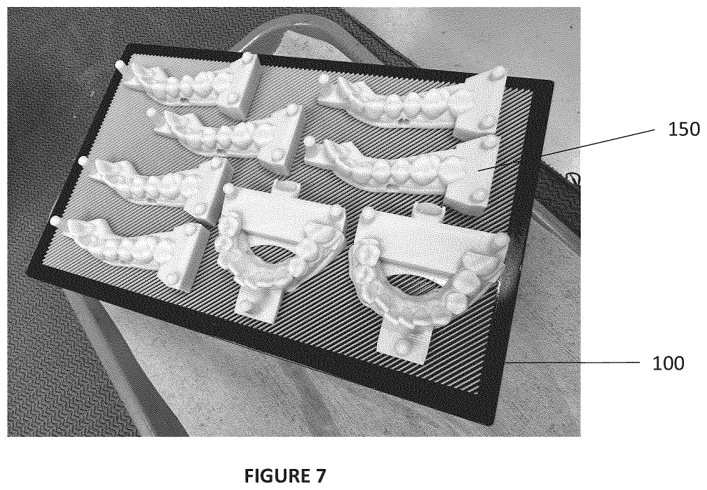

Examples of microsupport arrays 120 having additively manufactured objects 150 thereon are shown in FIGS. 5-7. As shown in FIG. 5, which shows a microsupport array 120 having an additively manufactured object 150 thereon, additional features may be present on and/or in the microsupport array 120. For example, support connectors 155 may connect two or more of the plurality of microsupports 100.

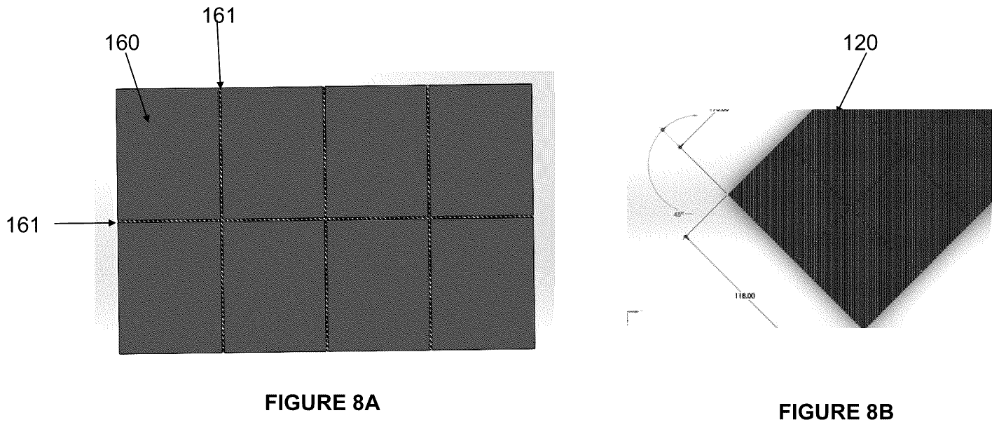

In some embodiments of the invention, the microsupport array 120 is on an intermediate structure or layer that is on the build platform. Referring to FIGS. 8A and 8B, in some examples, the intermediate structure is a base layer 160 (including a single panel or a series of panels) with or without channels 161 therein. Channels 161 in the base layer 160 may facilitate resin flow from the build platform and/or decrease print forces. In some embodiments, a width of the channel(s) 161 is in a range of 0.025 mm to 10 mm or 20 mm (e.g., 0.5 mm to 2 mm or 0.75 mm to 1.5 mm). Such base layers 160 may be formed in any shape such as a flat polygonal, circular, or ovate shape. In some embodiments, a thickness of such base layer 160 is in a range of 0.025 mm to 50 mm (e.g., 0.5 mm to 5 mm or 1 mm to 2 mm). In some embodiments, the base layer 120 may be perforated with holes of various shapes and sizes, for example, to decrease resin usage and decrease print forces. The direction of the microsupport arrays 120 on build platform (not shown) or base layer 160 (or other surface) may also vary. For example, as shown in FIG. 8B, the microsupport array 120 may be rotated (e.g., 10 degrees to 90, including 10, 20, 30, 45, 50, 60, 70, 80, or 90 degrees, or any range defined between any two of the foregoing values) relative to either of the x-y edges of the build surface.

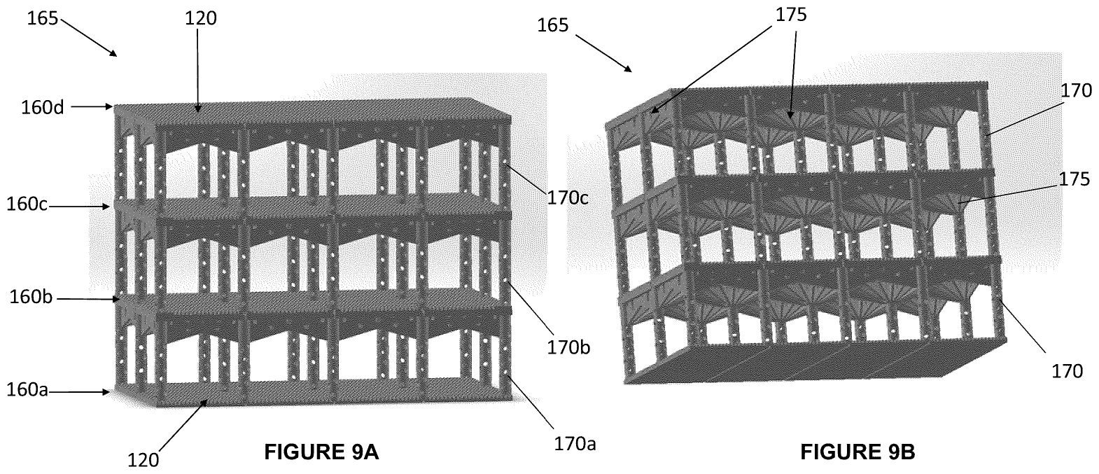

Multiple base layers 160 may be stacked to form multi-tiered structures. Accordingly, a plurality of microsupport arrays may be additively manufactured on the same build platform with additively manufactured objects being formed between the plurality of microsupport arrays, and the microsupport arrays may be spaced apart and supported by support pillars. FIGS. 9A and 9B show multi-tiered structures 165 that may include microsupport arrays 120 of the invention. Such multi-tiered structures 165 may include two or more (e.g., 3, 4, 5, 10, 20, 30, 40, 50, or more) base layers 160. In the multi-tiered structures 165 in FIGS. 9A and 9B, a first base layer 160a includes one or more microsupport array(s) 120 and support pillars 170a thereon. Second base layer 160b having one or more microsupport array(s) 120 thereon is on support pillars 170a. Third base layer 160c having one or more microsupport array(s) 120 thereon is on support pillars 170b. Fourth base layer 160d having one or more microsupport array(s) 120 thereon is on support pillars 170c. Other multi-tiered structures are envisioned. For example, multi-tiered structures 165 wherein the first microsupport array 120 is directly on the build platform may be used. In addition, any of the tiers or base layers 160 may or may not have microsupport arrays 120 thereon. For example, in some embodiments, the build platform may only contact the support pillars 170 and no first tier or base layer 160 is present.

Support pillars 170 can be made in any suitable shape, including, for example, cylindrical columns, half circles, rhombus, star-shaped, triangular, oval, polygonal, irregular, or any combination thereof. In particular embodiments, the support pillars 170 are cylindrical columns (e.g., having a width in a range of 0.1 mm to 50 mm (e.g., 0.5 mm to 10 mm or 5 mm to 7 mm). In some embodiments, support pillars 170 are hollow (including a void space throughout the length of the support pillar 170). In some embodiments, the outer to inner diameter ratio of the hollow support pillars 170 is in a range of 1.05:1 to 500:1 (e.g., in a range of 1.1:1 to 5:1 or 1.3:1 to 2:1). The support pillars 170 may be perforated or solid. If perforated, in some embodiments, the solid volume to hollow volume ratio is in a range of 1:100 to 100:1 (e.g., 1:50 to 50:1 or 1:3 to 3:1). The height of the support pillars 170 may be varied. For example, in some embodiments, the height of the support pillars 170 are in a range of 2 mm to 1000 mm (e.g., in a range of 20 mm to 100 mm or in a range of 30 mm to 70 mm).

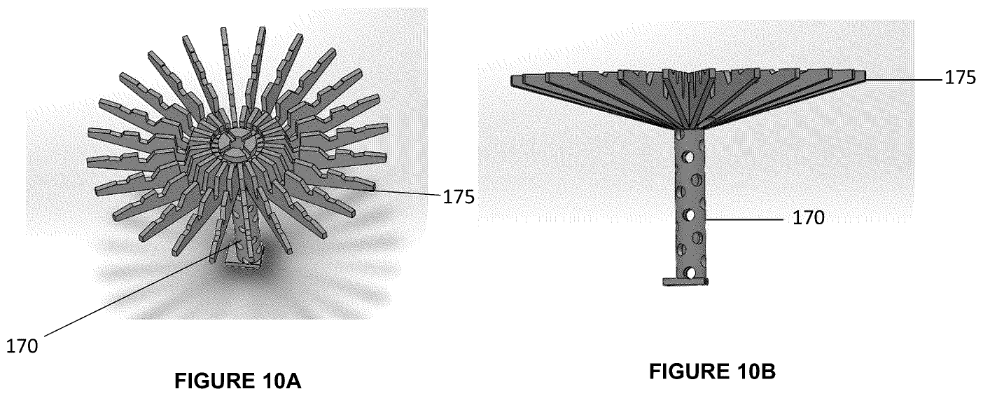

In some embodiments, the multi-tiered structures 165 may include additional support structures such as support beams 175 to help support the base layers 160. In some cases, support beams 175 may be attached to the support pillars 170, as more clearly shown in the perspective shown in FIG. 9B. FIGS. 10A and 10B illustrate magnified views of support pillars 170 and additional support structures 175. In some embodiments, support beams 175 extend radially from the support pillars 170 and contact a base layer 160 (not shown). Such support beams 175 may be solid or perforated to decrease resin use and facilitate resin flow. Other support structures 175 could be used including a conic structure projecting from the support pillar 170.

A wide variety of materials may be used to form the microsupports 100 of the invention. However, in some embodiments, the microsupports 100 are formed of a polymer and/or are formed by additive manufacturing process.

Referring FIGS. 5-7, in some embodiments of the invention, provided are additively manufactured combinations comprising a microsupport array 120 of the invention and an additively manufactured object 150 (e.g., a polymeric object) attached to the microsupport array 120. In some embodiments, part or all of the microsupport(s) 100 (e.g., the rail portion or a portion above a deflection point) is embedded or extends into the additively manufactured object 150, for example, after a portion of the microsupport 100 breaks upon removal of the additively manufactured object from the build platform. In some embodiments, as shown in FIG. 6, the combination comprises multiple microsupport arrays 120, wherein each microsupport array 120 has at least one additively manufactured object 150 thereon.

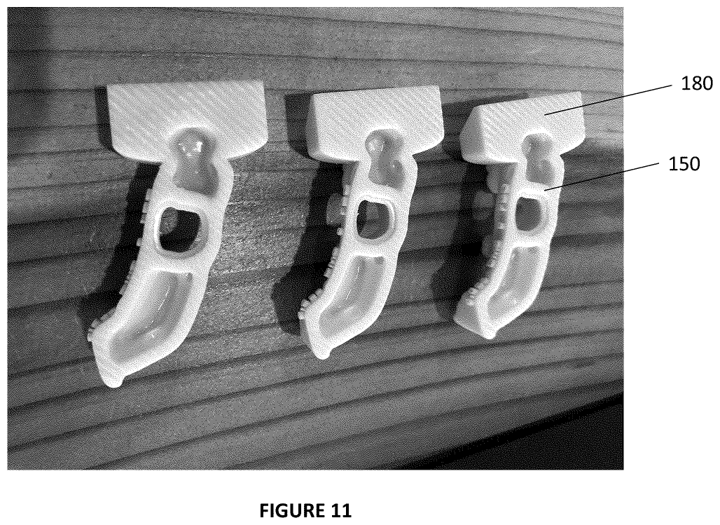

Also provided according to embodiments of the invention are additively manufactured objects 150 fabricated on a microsupport array 120 of the invention. In some embodiments, a portion of the microsupport(s) 100 (e.g., the rail portion, not shown) becomes embedded into the additively manufactured object 150 upon removal of the additively manufactured object 150 from the microsupport array 120. Accordingly, in some embodiments, as shown in FIG. 11, provided are additively manufactured objects 150 that include at least one surface having a plurality of additively manufactured polymeric fragments 180, each fragment 180 comprising a portion of the microsupport 100, embedded therein. In some embodiments, the additively manufactured polymer fragments 180 are arranged to form a pattern selected from the group consisting of a circle, triangle, diamond, polygon (e.g., hexagon), and a combination of any of the foregoing. In some embodiments, each polymer fragment 180 is a line segment, optionally wherein the plurality of polymer fragments 180 comprises an array of line segments (e.g., parallel line segments). In some embodiments, the polymer fragments 180 have a width in a range of 0.1 mm to 0.6 mm.

Also provided according to embodiments of the invention are methods of additively manufacturing an object 150. Such methods may include additively manufacturing a microsupport array 120 on (directly or indirectly) a build platform 125; additively manufacturing the object 150 on the microsupport array 120; and removing the object 150 from the microsupport array 120. In some embodiments, a portion of the microsupport(s) breaks upon removal of the object 150 from the microsupport array 120 such that a portion (e.g., the rail portion) remains embedded in the object 150 after removal from the microsupport array 120.

In some embodiments, additively manufacturing a microsupport array 120 on (directly or indirectly) a build platform 125 includes additively manufacturing an intermediate structure (e.g., a base layer 160 or a multi-tiered structure 165) on the build platform, and additively manufacturing the microsupport array 120 on the intermediate structure. In some embodiments, the removal of the object 150 from the microsupport array 120 is performed without the use of any clipping and/or breaking tools. In some embodiments, the object 150 includes a hollow portion and the method further includes draining residual resin from the hollow portion of the object 150 while the object 150 is on the microsupport array 120. Also provided according to some embodiments of the invention is an additively manufactured object 150 produced by a method of the invention.

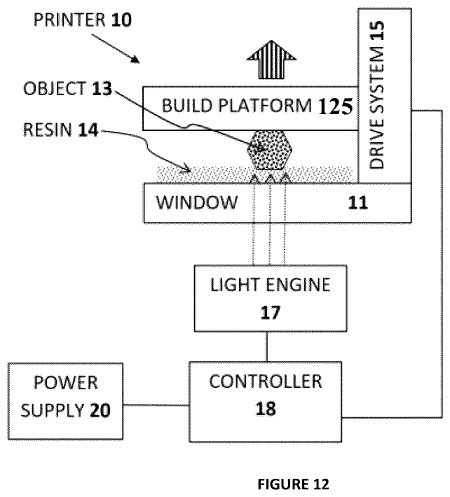

In some embodiments, a microsupport array 120 on (directly or indirectly) a build platform 125 may be included in an additive manufacturing apparatus, such as the additive manufacturing apparatus in FIG. 12. As illustrated in FIG. 12, the additive manufacturing apparatus or 3d printer 10 includes a light transmissive window or optically transparent member 11 on which a light polymerizable resin 14 can be supported. The optically transparent member 11 provides a build surface. A light engine or radiation source 17 is positioned below the optically transparent member 11 and opposite the build surface. A carrier or build platform 125 is positioned above the optically transparent member 11, and an object 13 can be produced thereon. The build surface of the optically transparent member 11 and the build platform 125 define a build region therebetween. A controller 18 powered by a power supply 20 is operatively associated with a drive assembly 15 and the light engine 17 to control the area illuminated by the light engine 17 and the drive system 15 to produce the object 13. The object 13 may be supported by or attached to the microsupport array 120 described above, which is provided on the build platform 125.

### Additive Manufacturing Methods, Apparatus, and Resins

The microsupport arrays, as described above, may be used in a variety of additive manufacturing processes. For example, additive manufacturing processes include stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and U.S. Patent Application Publication No. 2013/0295212 to Chen et al. Such techniques may be used herein.

Resins for additive manufacturing of polymer articles are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester; objects comprised of silicone, etc. Any suitable resin may be used to form the microsupport arrays, intermediate structures, and/or parts of the invention, including single cure, dual cure, elastomer-forming resins, and thermoset-forming resins.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewicz et al., Layerless fabrication with continuous liquid interface production, Proc. Natl. Acad. Sci. USA 113, 11703-11708 (Oct. 18, 2016). In some embodiments, CLIP employs features of a bottom-up three-dimensional fabrication as described above, but the irradiating and/or the advancing steps are carried out while also concurrently maintaining a stable or persistent liquid interface between the growing object and the build surface or window, such as by: (i) continuously maintaining a dead zone of polymerizable liquid in contact with the build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see I. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: Batchelder et al., Continuous liquid interface production system with viscosity pump, US Patent Application Pub. No. U.S. 2017/0129169 (May 11, 2017); Sun and Lichkus, Three-dimensional fabricating system for rapidly producing objects, U.S. Patent Application Pub. No. 2016/0288376 (Oct. 6, 2016); Willis et al., 3d print adhesion reduction during cure process, U.S. Patent Application Pub. No. 2015/0360419 (Dec. 17, 2015); Lin et al., Intelligent 3d printing through optimization of 3d print parameters, U.S. Patent Application Pub. No. 2015/0331402 (Nov. 19, 2015); and D. Castanon, Stereolithography System, U.S. Patent Application Pub. No. 2017/0129167 (May 11, 2017).

In some embodiments of the invention, provided are additive manufacturing apparatus for fabricating a three-dimensional object, that include a build platform; an optically transparent member having a build surface, the build surface and the build platform defining a build region therebetween; a polymerizable liquid supply operatively associated with the build surface and configured to supply liquid polymer into the build region for solidification or polymerization; a radiation source configured to irradiate the build region through the optically transparent member to form a solid polymer from the polymerizable liquid; an elevator assembly operatively associated with the build platform and/or the optically transparent member, the elevator assembly configured for modify the distance between the build platform and the optically transparent member; and a controller operatively associated with the build platform and/or optically transparent member; the radiation source; and the elevator assembly.

In some embodiments of the invention, provided are methods of additively manufacturing a three-dimensional object that include providing a build platform and an optically transparent member having a build surface, the build platform and optically transparent member defining a build region therebetween, said optically transparent member carrying a polymerizable liquid; irradiating the build region through the optically transparent member to produce a solid polymer portion in the build region; advancing the build platform with the solid polymer portion adhered thereto away from the optically transparent member and/or advancing the optically transparent member away from the build platform, to create a subsequent build region between the solid polymer portion and the build surface, and filling the subsequent build region with the polymerizable liquid; continuing and/or repeating steps (b) and (c) to produce a subsequent solid polymer portion adhered to a previous solid polymer portion until the continued or repeated deposition of solid polymer portions adhered to one another forms the three-dimensional object.

The foregoing is illustrative of the present invention, and is not to be construed as limiting thereof. The invention is defined by the following claims, with equivalents of the claims to be included therein.

What is claimed is:

1. A microsupport array for additive manufacturing, comprising a plurality of microsupports on a build platform, wherein each microsupport comprises:
(i) a base portion on the build platform,
(ii) a rail portion configured to attach to an additively manufactured object, and
(iii) a body portion connecting the base portion and the rail portion, optionally wherein the body portion comprises a deflection point,
wherein a part of the body portion is configured to break upon removal of the additively manufactured object from the build platform at the deflection point, when present.

2. The microsupport array of claim 1, wherein at least part of the rail portion is configured to extend into the additively manufactured object upon removal of the additively manufactured object from the build platform.

3. The microsupport array of claim 1, wherein the microsupports have a height in a range of 0.025 to 30 mm and a base width in a range of 0.025 to 30 mm.

4. The microsupport array of claim 1, wherein the microsupports have a length in a range of 0.5 mm to 1000 mm, optionally wherein the length of the microsupports is at least 5 times greater than the height of the microsupports.

5. The microsupport array of claim 1, wherein the microsupports are elongate structures having a length at least 5 times greater than the height, optionally wherein the microsupports are substantially parallel, and optionally wherein the microsupports are separated by a distance in a range of 1 mm to 3 mm.

6. The microsupport array of claim 1, wherein the plurality of microsupports is arranged in a pattern selected from the group consisting of a circle, triangle, diamond, polygon, hexagon, and a combination of any of the foregoing.

7. The microsupport array of claim 1, wherein a configuration of the plurality of microsupports is irregular and/or non-uniform.

8. The microsupport array of claim 1, wherein the microsupports are directly or indirectly on at least 5% or more of the surface area of the build platform.

9. The microsupport array of claim 1, wherein the plurality of microsupports is directly on the build platform.

10. The microsupport array of claim 1, wherein the plurality of microsupports is on an intermediate structure that is directly or indirectly on the build platform.

11. The microsupport array of claim 1, wherein the microsupport array is provided as an additively manufactured combination comprising an additively manufactured object attached to the microsupport array.

12. The microsupport array of claim 11, wherein at least part of the rail portion of the microsupports is embedded into the additively manufactured object and at least a part of the rail portion is configured to remain in the additively manufactured object when the object is removed from the build platform or an intermediate structure on the build platform.

13. The microsupport array of claim 11, wherein the additively manufactured combination comprises multiple microsupport arrays, wherein each microsupport array of the multiple microsupport arrays has at least one additively manufactured object thereon.

14. An additively manufactured object comprising:
at least one surface having a plurality of additively manufactured polymeric fragments embedded therein.

15. The additively manufactured object of claim 14, wherein the additively manufactured polymer fragments are arranged to form a pattern selected from the group consisting of a circle, triangle, diamond, polygon, hexagon, and a combination of any of the foregoing.

16. The additively manufactured object of claim 14, wherein each polymer fragment is a line segment, optionally wherein the plurality of polymer fragments comprises an array of line segments, optionally wherein the line segments are separated by 1 mm to 3 mm.

17. The additively manufactured object of claim 14, wherein a portion of each of the polymer fragments has a width in a range of 0.1 mm to 0.6 mm.

18. A method of additively manufacturing an object comprising:
(a) additively manufacturing a microsupport array directly or indirectly on a build platform;
(b) additively manufacturing the object on the microsupport array; and
(c) removing the object from the microsupport array,
wherein the microsupport array comprises a plurality of microsupports and each microsupport includes:
(i) a base portion directly or indirectly on the build platform,
(ii) a rail portion that attaches to the object, and
(i) a body portion connecting the base portion and the rail portion,
wherein a portion of the microsupport is configured to break upon removal of the object from the microsupport array such that at least part of the rail portion remains in the object after removal step (c).

19. The method of claim 18, further comprising additively manufacturing an intermediate structure on the build platform, and additively manufacturing the microsupport array on the intermediate structure.

20. The method of claim 18, wherein the object includes a hollow portion and in step (b), after additively manufacturing the object, residual resin is drained from the hollow portion while the object is on the microsupport array.

21. The method of claim 18, wherein removal of the object from the microsupport array is performed without the use of any clipping and/or breaking tools.
